(19) United States
(12) Patent Application Publication
(10) Pub. No.: US 2026/0276138 A1
(43) Pub. Date: Sep. 17, 2026

(54) SUPPORT ASSEMBLY WITH ADJUSTABLE LOCKING DEGREE, AND PHOTOGRAPHY SUPPORT FRAME

(71) Applicant: SHENZHEN LEQI INNOVATION CO., LTD., SHENZHEN (CN)

(72) Inventors: LIANG GUO, SHENZHEN (CN); SHAORUI TANG, SHENZHEN (CN); JIANLEI ZHANG, SHENZHEN (CN)

(21) Appl. No.: 19/565,606

(22) Filed: Mar. 13, 2026

(30) Foreign Application Priority Data
Mar. 14, 2025 (CN) 202520467575.8

(51) Int. Cl. F16M 11/32; F16M 11/04; G03B 17/56

(52) U.S. Cl. CPC F16M 11/32; F16M 11/041; G03B 17/561; F16M 2200/027

(57) ABSTRACT

The present disclosure provides a support assembly with an adjustable locking degree, and a photography support frame. The assembly includes a telescopic tube assembly including an outer tube and inner tubes, and a first locking assembly. The first locking assembly includes a first bushing connected to the outer tube and having an avoiding space, a second bushing connected to a first inner tube and having an external thread, and a locking sleeve with an internal thread and a tapered first abutting portion. Rotation of the locking sleeve generates radial pressure via the tapered abutting portion to adjust the locking force between tube sections. The photography support frame incorporates multiple such support assemblies, a mounting seat, and a centralized operation member.

### CROSS-REFERENCE TO RELATED APPLICATION

This application is based on and claims priority to China Patent Application No. 2025204675758, filed on Mar. 14, 2025, the entire contents of which are incorporated herein by reference.

### FIELD

The present disclosure relates to the technical field of photographic and videographic equipment, especially relates to a support assembly with an adjustable locking degree, and a photography support frame.

### BACKGROUND

With the increasing demand for photography and video creation, various photographic auxiliary equipment continues to emerge. As one of the common photographic auxiliary devices, the photography support frame provides stable support for cameras or other shooting devices, thereby reducing image shake that may be caused by handheld operation or instable platform, and improving shooting quality.

Common photography support frames currently available on the market include monopods, tripods, and certain specialized support structures. These support assemblies of the photography support frame typically consist of multiple telescoping tube sections, allowing height or angle adjustment through their extension and retraction. The locking mechanisms between the multipletubes typically employ manual screw tightening or clamping structures. For example, a locking sleeve with a first connecting portion cooperates with a pressing assembly having a second connecting portion to achieve locking, or a cam mechanism is used to push a locking block into place for securing.

However, such locking mechanism in related art has the following shortcomings. Due to the relatively simple structure of the locking components, they can only secure the tubes in place but cannot adjust the tightness of the lock. This often leads to issues such as tube slippage when the lock is too loose or tube jamming when the lock is too tight.

### SUMMARY

The main purpose of the present disclosure is to propose a support assembly with an adjustable locking degree, aiming to solve the issue of non-adjustable locking degree between tubes.

To achieve the above purpose, the present disclosure proposes a support assembly with an adjustable locking degree, which is configured to support an equipment. The support assembly includes:
a telescopic tube assembly which includes an outer tube, a first inner tube disposed within the outer tube and being capable of sliding relative to the outer tube in an axial direction, and a second inner tube disposed within the first inner tube and being capable of sliding relative to the first inner tube in the axial direction.

The support assembly further includes a first locking assembly, and the first locking assembly includes:
a first bushing connected to one end of the outer tube, wherein a peripheral wall of the first bushing defines an avoiding space;
a second bushing connected to one end of the first inner tube, the second bushing being provided with a first connecting portion which is capable of passing through the avoiding space; and
a locking sleeve. An inner wall of the locking sleeve is provided with a second connecting portion for cooperating with the first connecting portion, one end of the locking sleeve is arranged with a first abutting portion which is linked to the locking sleeve, an inner wall of the first abutting portion abuts against the second inner tube, an outer wall of the first abutting portion embeds into a gap formed between the first bushing and the second inner tube, and the outer wall of the first abutting portion is configured to be tapered.

In some embodiments, one end of the first bushing close to the first abutting portion is provided with a second propping ring, and an inner wall of the second propping ring abuts against the outer wall of the first abutting portion.

In some embodiments, the first connecting portion is an external thread, the second connecting portion is an internal thread, and the first bushing is connected to the second propping ring via a threaded connection of the external thread and the internal thread.

In some embodiments, an inner wall of the second propping ring contacts with the outer wall of the first abutting portion, and the inner wall of the second propping ring and the outer wall of the first abutting portion are both configured to be tapered.

In some embodiments, one end of the second propping ring close to the first abutting portion is arranged with a first protrusion.

In some embodiments, one end of the locking sleeve defines an annular groove extending along an inner wall of the locking sleeve, an end of the first abutting portion opposite to the second propping ring is arranged with a second protrusion, the second protrusion is clamped in the annular groove, and the locking sleeve is capable of rotating relative to the second propping ring when subjected to an external rotational force.

In some embodiments, the telescopic tube assembly further includes a third inner tube disposed within the second inner tube, and a fourth inner tube disposed within the third inner tube.

The support assembly further includes a second locking assembly disposed at one end of both the second inner tube and the third inner tube. A structure of the second locking assembly is identical to that of the first locking assembly.

In some embodiments, the support assembly further includes a first driving member disposed at another end of the outer tube. The first driving member includes an executing end extended into the outer tube and connected to another end of the first inner tube. The first driving member is configured to drive the first inner tube to move axially relative to the outer tube.

In some embodiments, the support assembly further includes a second driving member disposed at another end of the second inner tube. The second driving member includes an execution end extended into the second inner tube and connected to the third inner tube. The second driving member is configured to drive the third inner tube to move axially relative to the second inner tube. The first driving member and the second driving member are connected by a fluid pipeline, and both the first driving member and the second driving member are hydraulic cylinders.

The present disclosure also proposes a photography support frame, which includes a mounting seat, an operation member, and a plurality of support assemblies with an adjustable locking degree according to the aforementioned embodiments. The plurality of support assemblies with an adjustable locking degree are connected to the mounting seat, and the mounting seat is configured to mount photographic equipment.

The operation member is connected to the first driving member of each support assembly, and configured to output driving force to the first driving member of each support assembly.

In some embodiments, the photography support assembly further includes a second driving member disposed at another end of the second inner tube. The second driving member has an execution end extended into the second inner tube and connected to the third inner tube, and the second driving member is configured to drive the third inner tube to move axially relative to the second inner tube. The first driving member and the second driving member are connected by a fluid pipeline, and both the first driving member and the second driving member are hydraulic cylinders. In some embodiments, the operation member is connected to the first driving member of each support assembly and configured to output driving force to the first driving member, and is also connected to the second driving member of each support assembly and configured to output driving force to the second driving member.

In the technical solution of the present disclosure, by providing the first abutting portion, whose inner wall closely fits the second inner tube and whose outer wall is tapered, and linking it with the locking sleeve that cooperates with the first connecting portion, when the locking sleeve is rotated, axial motion can be converted into radial pressure. Through the first abutting portion embedding into the gap between the first bushing and the second inner tube, adjustment and uniform distribution of the locking force are achieved. This effectively prevents issues such as tube slippage caused by insufficient locking or tube jamming caused by over-tightening, ensuring the stability and reliability of the support assembly during use.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is an overall structural diagram of a support assembly according to an embodiment of the present disclosure.

FIG. 2 is another overall structural diagram of a support assembly according to an embodiment of the present disclosure.

FIG. 3 is a cross-sectional view of FIG. 2 taken along line A-A.

FIG. 4 is another cross-sectional view of FIG. 2 with different viewing angle of FIG. 3.

FIG. 5 is an enlarged view of area B in FIG. 4.

FIG. 6 is an enlarged view of area C in FIG. 4.

FIG. 7 is an enlarged view of area D in FIG. 4.

FIG. 8 is an exploded view of the first locking assembly.

FIG. 9 is another exploded view of the first locking assembly.

FIG. 10 is an enlarged view of area E in FIG. 4.

### REFERENCE NUMERALS

100, telescopic tube assembly; 110, outer tube; 111, first inner tube; 112, second inner tube; 200, first locking assembly; 210, first bushing; 210a, avoiding space; 212, second propping ring; 212a, first protrusion; 220, second bushing; 220a, first connecting portion; 230, locking sleeve; 230a, second connecting portion; 232, first abutting portion; 230b, annular groove; 232a, second protrusion; 300, second locking assembly; 113, third inner tube; 114, fourth inner tube; 400, first driving member; 500, second driving member; 600, fluid pipeline; 700, photography support frame; 710, mounting seat; 712, operation member.

The realization of the aim, functional characteristics, advantages of the present disclosure are further described specifically with reference to the accompanying drawings and embodiments.

### DETAILED DESCRIPTION

The technical solutions in the embodiments of the present disclosure will be clearly and completely described below in conjunction with the accompanying drawings in the embodiments of the present disclosure. It is obvious that the described embodiments are only part of the embodiments of the present disclosure, not all of them. Based on the embodiments of the present disclosure, all other embodiments obtained by those of ordinary skill in the art without creative work shall fall within the scope of protection of the present disclosure.

It should be noted that all directional indications (such as up, down, left, right, front, back, etc.) in the embodiments of the present disclosure are only used to explain the relative positional relationship, movement conditions, etc., between the components under a specific posture (as shown in the accompanying drawings). If the specific posture changes, the directional indications will also change accordingly.

It should also be noted that when an element is referred to as being “fixed to” or “disposed on” another element, it can be directly on the other element or there may be an intervening element at the same time. When an element is referred to as being “connected to” another element, it can be directly connected to the other element or there may be an intervening element at the same time.

In addition, descriptions involving “first”, “second”, etc., in the present disclosure are for descriptive purposes only and shall not be construed as indicating or implying their relative importance or implicitly indicating the number of indicated technical features. Thus, features defined with “first”, “second” may explicitly or implicitly include at least one such feature. In addition, the technical solutions of the various embodiments can be combined with each other, but must be based on the realization by those of ordinary skill in the art. When a combination of technical solutions is contradictory or cannot be realized, it shall be considered that such a combination of technical solutions does not exist and is not within the scope of protection claimed by the present disclosure.

In related art, photography support frames commonly available on the market include monopods, tripods, and certain specialized support structures. These support assemblies are typically composed of multiple telescoping tube sections, which adjust height or angle through mutual extension and retraction. However, traditional multi-section tubes typically employ fixed locking mechanisms that do not allow for precise adjustment of the tightness of locking. This often leads to two practical issues during use: first, insufficient tightening may cause the tube sections to unexpectedly slip under load, posing a risk of equipment damage; second, excessive tightening can result in binding, not only compromising operational experience but also potentially accelerating component wear. To address this technical deficiency, the present disclosure proposes a support assembly with an adjustable locking degree, aiming to resolve the insufficient adjustment precision of traditional locking mechanisms and to enhance support stability and service life.

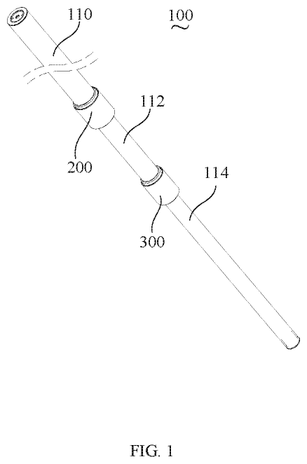

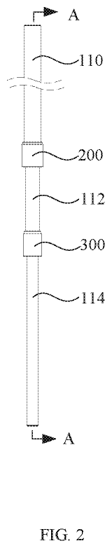

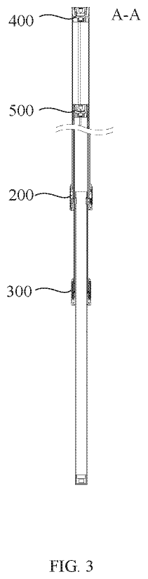

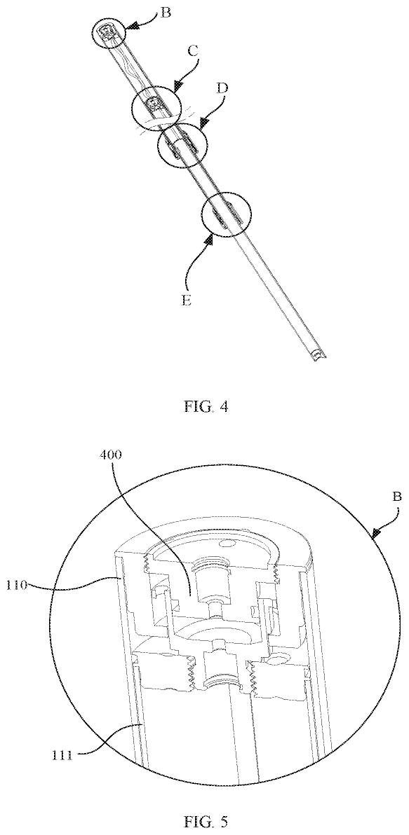

In the present disclosure, the support assembly with an adjustable locking degree is not only applicable in the field of photographic equipment, such as tripods and monopods for single-lens reflex cameras, mirrorless cameras, and camcorders, but also widely applicable in numerous other fields including easel supports for fine arts and painting, leveling instrument supports for measuring equipment, observation stands for outdoor telescopes, infusion stands for medical equipment, adjustment brackets for stage lighting, and equipment support stands for outdoor live streaming. It offers high adjustment precision, reliable locking, and convenient operation. Referring to FIGS. 1 to 9, an embodiment of the disclosure proposes a support assembly with an adjustable locking degree, configured to support equipment. This support assembly with an adjustable locking degree includes:
a telescopic tube assembly 100, which includes an outer tube 110 and a first inner tube 111 disposed within the outer tube 110. The first inner tube 111 is capable of sliding axially relative to the outer tube 110;
a second inner tube 112, which is disposed within the first inner tube 111 and capable of sliding axially relative to the first inner tube 111; and
a first locking assembly 200, which includes:
a first bushing 210, connected to one end of the outer tube 110, with its peripheral wall configured with an avoiding space 210a;
a second bushing 220, connected to one end of the first inner tube 111, and configured with a first connecting portion 220a capable of passing through the avoiding space 210a;
a locking sleeve 230, whose inner wall is configured with a second connecting portion 230a matched with the first connecting portion 220a. One end of the locking sleeve 230 is provided with a first abutting portion 232. The first abutting portion 232 is coupled to the locking sleeve 230, has an inner wall adhering to the second inner tube 112, an outer wall embedded in a gap between the first bushing 210 and the second inner tube 112, and is configured to be tapered.

In this embodiment, the telescopic tube assembly 100 serves as the core structure of the support assembly, primarily providing height adjustment functionality and load-bearing capacity. The telescopic tube assembly 100 includes the outer tube 110 and the first inner tube 111 disposed within the outer tube 110. The first inner tube 111 can slide axially relative to the outer tube 110 to achieve first stage of telescopic adjustment. The outer tube 110 may be made of aluminum alloy, offering a balance of lightweight and sufficient strength, and its outer surface may feature an anti-slip texture design to enhance grip stability. The first inner tube 111 may also be made of aluminum alloy or carbon fiber to reduce weight while maintaining sufficient rigidity. An appropriate gap is designed between the outer tube 110 and the first inner tube 111 to ensure smooth sliding, with precision machining to prevent significant wobble during extension or retraction.

The first locking assembly 200 in this embodiment not only provides a locking function but, more crucially, enables precise adjustment of the locking degree. By providing the first abutting portion 232 whose inner wall adheres to the second inner tube 112 and whose outer wall is tapered, a mechanical conversion system is formed by coupling the first abutting portion 232 with the locking sleeve 230 that cooperates with the first connecting portion 220a. When the operator rotates the locking sleeve 230, the interaction between the second connecting portion 230a on the locking sleeve 230 and the first connecting portion 220a on the second bushing 220 converts rotational motion into axial motion. The tapered design then transforms the axial force into radial pressure. Due to its tapered outer wall design, the first abutting portion 232 generates varying magnitudes of radial squeezing force depending on the degree of axial displacement, and accurately embeds into the gap between the first bushing 210 and the second inner tube 112. This achieves continuous and adjustable distribution of the locking force. This design ingeniously solves the technical challenge of traditional locking devices that cannot be finely adjusted, effectively preventing issues such as tube slippage caused by insufficient locking or tube stuck caused by excessive locking.

In a practical application scenario, taking a photographic tripod as an example, when adjusting the support height, user first operates a first driving member 400 to unlock the first locking assembly 200 via the first inner tube 111. At this point, the radial pressure exerted by the first abutting portion 232 on the second inner tube 112 decreases, placing the first locking assembly 200 in an unlocked state. Under gravity, the second inner tube 112 can freely slide out from the first inner tube 111, remaining in an extended state. User can then operate the outer tube 110 and the first inner tube 111 to slide together relative to the second inner tube 112 to find a suitable height according to shooting needs.

Once the ideal height is found, user operates the first driving member 400 to lock the first locking assembly 200 via the first inner tube 111. If user feels the locking degree is insufficient and worries about potential slippage when mounting a heavy camera or telephoto lens, they can adjust the locking degree by rotating or axially moving the first locking sleeve 230. The adjustment of the locking sleeve 230, through the cooperation of the first connecting portion 220a and the second connecting portion 230a, drives the first abutting portion 232 to further embed into the gap, increasing radial pressure and thereby enhancing the locking force. This continuously adjustable locking mechanism allows user to accurately adjust the locking strength according to different loads, ensuring that the equipment remains secure and stable.

When the shooting task is completed and the equipment needs to be stored, user operates the first driving member 400 again. The first inner tube 111 disengages the lock of the first locking assembly 200, allowing the second inner tube 112 to retract smoothly into the first inner tube 111 for compact storage. If during use the locking is found to be too tight, causing inconvenience in adjustment, the user can also adjust the first locking sleeve 230 to reduce the locking force to an appropriate level, ensuring both a secure lock and a smooth operational experience. This adjustable design is particularly suitable for outdoor shooting environments, where users can flexibly adjust the locking tightness based on temperature changes (which affect metal expansion and contraction) or special terrain conditions (such as, a tighter lock is required on bumpy ground), thereby improving the equipment's adaptability and safety.

In the present disclosure, by providing the first abutting portion 232 whose inner wall adheres to the second inner tube 112 and whose outer wall is tapered, and coupling it with the locking sleeve 230 that cooperates with the first connecting portion 220a, when the locking sleeve 230 is rotated, axial motion can be converted into radial pressure. The first abutting portion 232 embeds into the gap between the first bushing 210 and the second inner tube 112, thereby achieving adjustment and uniform distribution of the locking force. This effectively prevents issues such as tube slippage caused by insufficient locking or tube stuck caused by excessive locking, ensuring the stability and reliability of the support assembly during use.

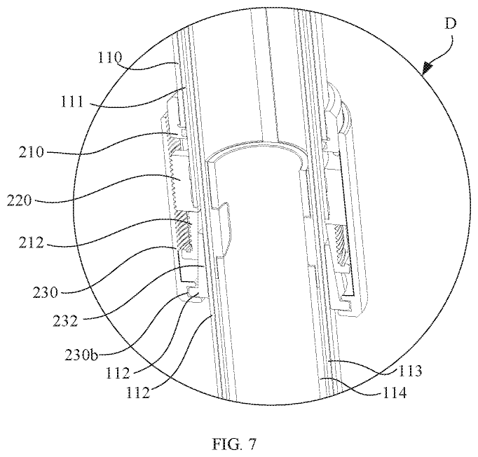

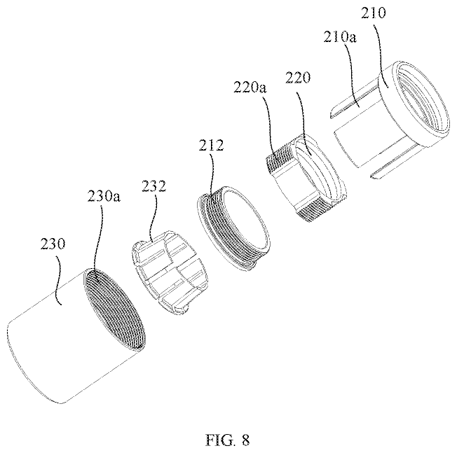

Referring to FIGS. 7 and 8, in this embodiment, a second propping ring 212 is disposed at an end of the first bushing 210 close to the first abutting portion 232. An inner wall of the second propping ring 212 closely contacts to an outer wall of the first abutting portion 232, forming a precise mating surface which is capable of providing more uniform force transmission during locking operations.

In a further refinement of this embodiment, the connection between the second propping ring 212 and the first bushing 210 is designed as an adjustable structure. The relative positions between the second propping ring 212 and the first bushing 210 may be finely adjusted through a threaded connection. User can alter the positional relationship between the second propping ring 212 and the first bushing 210 by rotating the second propping ring 212. This design ingeniously provides a second-stage adjustment mechanism for the locking system, enabling more precise control over the locking degree.

When a user needs finer adjustment of the locking force, they can finely adjust the position of the second propping ring 212 while maintaining the first locking assembly 20 in a basically locked state. By rotating the second propping ring 212 clockwise, the second propping ring 212 can be moved towards the first abutting portion 232, increasing the compressive force on the outer wall of the first abutting portion 232, thereby indirectly enhancing the locking force of the first abutting portion 232 on the second inner tube 112. Conversely, counterclockwise rotation reduces this pressure, achieving a gentler locking effect.

This provides a wider adjustment range for locking force, capable of accommodating various load requirements from lightweight equipment to heavy-duty professional gear. Further, it allows users to fine-tune the locking force without fully unlocking the mechanism, enhancing operational safety. Additionally, this design improves the reliability of the locking system. Even if one adjustment mechanism experiences slight wear after prolonged use, the other mechanisms can still ensure sufficient locking effectiveness, thus extending the product's service life.

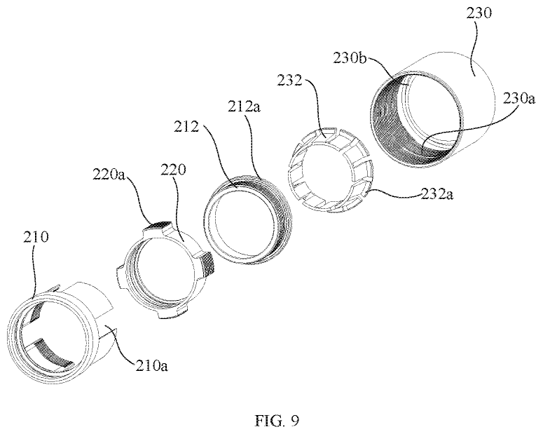

Continuing to refer to FIGS. 8 and 9, the first connecting portion 220a is an external thread, and the second connecting portion 230a is an internal thread. The first bushing 210 and the second propping ring 212 are connected via the threaded connection structure, ensuring reliable connection and precise adjustment capability among the components of the locking assembly.

In this embodiment, the threaded connection structure may employ a precision trapezoidal thread. Compared to ordinary triangular threads, trapezoidal threads offer a larger contact area and superior force-bearing characteristics, providing more stable force transmission during locking process, reducing wear, and extending service life. The thread pitch is designed as a fine pitch, resulting in a smaller axial displacement per rotation, facilitating the user's fine adjustment of the locking tightness.

Beyond the threaded connection, the disclosure may also achieve an adjustable connection between the first bushing 210 and the second propping ring 212 through other technical solutions.

For example, a ratcheted adjustment structure is provided, the outer wall of the first bushing 210 is provided with multi-stage annular grooves, and the inner wall of the second propping ring 212 is provided with corresponding detents. The user can press a release mechanism to make the detents jump from one groove to another, achieving stepwise adjustment.

Another example is an elastic material adjustment layer. A special elastic material layer is arranged between the first bushing 210 and the second propping ring 212. The elastic modulus of this material layer can change with temperature or an applied electric field. By controlling the state of the elastic material via a heating element or microcurrent, stepless adjustment of the contact pressure is achieved, offering advantages such as no noise and no mechanical wear.

Continuing to refer to FIG. 7, in this embodiment, the inner wall of the second propping ring 212 contacts the outer wall of the first abutting portion 232. Both the inner wall of the second propping ring 212 and the outer wall of the first abutting portion 232 are configured to be tapered. The taper of the inner wall of the second propping ring 212 matches the taper of the outer wall of the first abutting portion 232, forming a large-area contacting interface. This ensures that force transmission is more uniform and effective. When the two tapered surfaces contact, even with minimal axial movement, significant changes in radial pressure can be generated, thus enabling precise control of the locking force.

First, the tapered surface contact provides a self-centering function, ensuring that the two components maintain coaxial alignment in any adjustment state. This prevents uneven locking or localized wear caused by eccentricity. Second, the dual-taper design allows a smaller operating force to be converted into a larger locking pressure. Furthermore, friction distribution on the tapered contact surface is more uniform, avoiding potential stress concentration issues that may arise from point contact or line contact. When the support assembly is subjected to torsional or lateral forces, this uniform contact provides better resistance and enhances overall structural stability.

Additionally, the dual-taper structure maintains good functionality under various environmental temperatures. For instance, when metal materials expand or contract due to temperature changes, the tapered surface contact can still adaptively adjust to maintain effective locking. This is particularly important for professional photographic equipment used outdoors.

In summary, the dual-taper design of the inner wall of the second propping ring 212 and the outer wall of the first abutting portion 232 not only improves the adjustment precision and operational convenience of the locking mechanism but also enhances the reliability and durability of the product under various operating conditions.

Continuing to refer to FIG. 7, in this embodiment, a first protrusion 212a is provided at an end of the second propping ring 212 close to the first abutting portion 232.

In this embodiment, the first protrusion 212a extends around the periphery of the end of the second propping ring 212 near the first abutting portion 232, forming an outward-facing limiting structure. When the support assembly is in a locked state or during the adjustment of the locking degree, the first protrusion 212a can establish an effective mechanical limit with the edge or an internal step surface of the first bushing 210. This effectively prevents the second propping ring 212 from being accidentally pushed into the first bushing 210 under the operational pressure from the first abutting portion. Without such a protrusion for limiting, under extreme usage conditions (such as heavy equipment load or external impact), the second propping ring 212 might dislodge from its working position and slide into the first bushing 210, resulting in the failure of the locking function or even structural damage to the entire support assembly.

Further, during the user's adjustment of the locking degree, the first protrusion 212a can limit the movement range of the second propping ring 212, preventing excessive adjustment that would cause the second propping ring 212 to extend too far into the first bushing 210. This limiting function not only protects the normal operation of the locking mechanism but also prevents situations where the user might struggle to return the structure due to excessive displacement during adjustment, ensuring the controllability and reversibility of the adjustment process.

Continuing to refer to FIG. 7, in this embodiment, one end of the locking sleeve 230 is configured with an annular groove 230b. The annular groove 230b is defined along the inner wall of the locking sleeve 230. An end of the first abutting portion 232 opposite to the second propping ring 212 is configured with a second protrusion 232a. The second protrusion 232a engages in the annular groove 230b. The locking sleeve 230 is capable of rotating relative to the second propping ring 212 under an external rotational force.

In this embodiment, when a user applies a rotational force to the locking sleeve 230 to adjust the locking degree, the locking sleeve 230 can freely rotate around its axis relative to the second propping ring 212. However, due to the engagement between the second protrusion 232a of the first abutting portion 232 and the annular groove 230b in the inner wall of the locking sleeve 230, the first abutting portion 232 can only move axially with the locking sleeve 232 and will not rotate relative to it.

This ensures that the first abutting portion 232 does not undergo rotational movement relative to the second inner tube 112 during the adjustment, thereby avoiding unnecessary frictional wear. Without this engagement and limiting, when the locking sleeve 230 rotates, the first abutting portion 232 might also rotate, causing rotational friction against the surface of the second inner tube 112. This would not only increase operational resistance but also accelerate wear on the contacting surfaces, shortening component lifespan.

Further, since the first abutting portion 232 does not rotate relative to the second propping ring 212 and only undergoes axial movement, stable relative positions between the two tapered contact surfaces are maintained. This ensures more uniform and controllable force transmission, preventing unstable locking issues caused by localized poor contact.

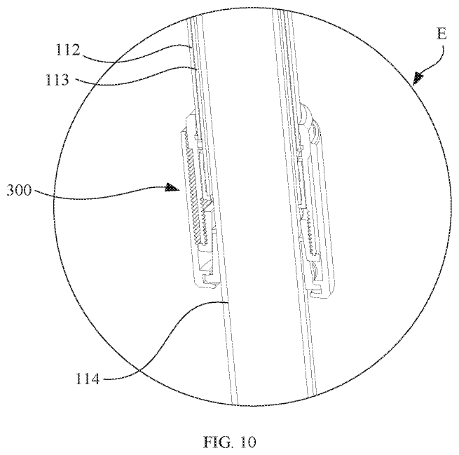

Referring to FIGS. 5, 6, 7, and 10, in this embodiment, the telescopic tube assembly 100 further includes a third inner tube 113 and a fourth inner tube 114 sequentially sleeved. The third inner tube 113 is disposed within the second inner tube 112.

The support assembly further includes a second locking assembly 300. The second locking assembly 300 is disposed at one end of the second inner tube 112 and the third inner tube 113. The structure of the second locking assembly 300 is consistent with that of the first locking assembly 200.

In this embodiment, by providing the third inner tube 113 and the fourth inner tube 114, the support assembly with an adjustable locking degree in this embodiment achieves a greater range of height adjustability, expanding its application scenarios and adaptability.

The multi-stage telescopic design allows the support assembly to maintain a compact size when fully retracted, making it easy to carry and store, while providing adequate working height when fully extended to meet the demands of various professional shooting or other application scenarios.

The second locking assembly 300 adopts the same structural design as the first locking assembly 200, including corresponding core components such as bushings, abutting portions, and locking sleeves. This ensures structural consistency and component interchangeability. This not only simplifies the manufacturing process and reduces production costs but also provides users with a consistent operational experience and reduces the learning curve for usage. The second locking assembly 300 also features an adjustable locking degree function, allowing users to accurately adjust the corresponding locking force based on the load conditions between the third inner tube 113 and the fourth inner tube 114.

It is worth noting that in the multi-stage tube design, the diameter and wall thickness of each tube section follow a reasonable decreasing proportion. This ensures sufficient strength while optimizing weight and space utilization. The third inner tube 113 and the fourth inner tube 114 can be made of high-strength, lightweight materials such as aerospace-grade aluminum alloy or carbon fiber composite, ensuring strength while minimizing overall weight. Furthermore, the multi-section telescopic design can reserve appropriate internal space for routing cables or hydraulic lines in specific application scenarios, such as the integration of electric control systems or hydraulic-assisted locking systems.

Continuing to refer to FIG. 5, in this embodiment, the support assembly with an adjustable locking degree further includes a first driving member 400. The first driving member 400 is disposed at another end of the outer tube 110. An execution end of the first driving member 400 extends into the outer tube 110 and connects to another end of the first inner tube 111. The first driving member 400 is configured to drive the first inner tube 111 to move axially relative to the outer tube 110.

This embodiment achieves automated control of the first locking assembly 200 by incorporating the first driving member 400, enhancing the operational convenience and precision of the support assembly. The first driving member 400 is mounted at the distal end of the outer tube 110. Its execution portion extends deep into the outer tube 110 to form a reliable connection with the distal end of the first inner tube 111, constituting a complete power transmission system.

When support height or locking state needs to be adjusted, user only needs to control the first driving member 400 to drive the first inner tube 111 to move axially relative to the outer tube 110. This movement is directly transmitted to the first locking assembly 200, achieving locking or unlocking operations without the need of operating the locking sleeve 230 or other mechanical components by user. This significantly reduces the complexity and physical effort of manual operation.

The first driving member 400 may be an electric motor drive, a hydraulic system, a pneumatic device, or a mechanical lever system. Taking electric drive as an example, a micro servo motor can be used in conjunction with a precision lead screw or rack-and-pinion mechanism to achieve precise control over the position of the first inner tube 111 by way of an electronic system, or even to preset multiple commonly used positions for one-touch positioning functionality.

This driving design is particularly suitable for professional photography work, especially in scenarios requiring frequent height adjustments or precise fine-tuning, as it can significantly improve work efficiency and reduce operational errors. Moreover, for equipment with heavy loads, the mechanical advantage provided by the driving member allows for easy locking and unlocking operations even under high load conditions, avoiding the operational difficulties that traditional manual systems might encounter.

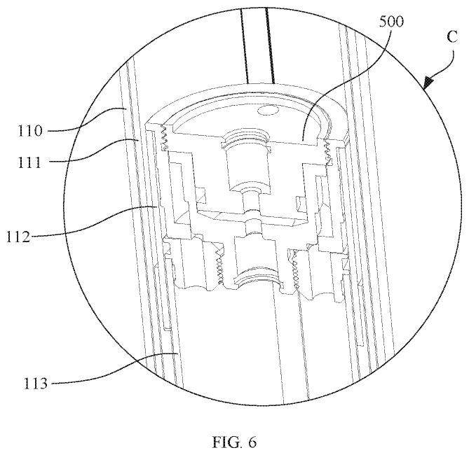

Continuing to refer to FIG. 6, further, the support assembly with an adjustable locking degree also includes a second driving member 500. The second driving member 500 is disposed at another end of the second inner tube 112. An execution end of the second driving member 500 extends into the second inner tube 112 and connects to the third inner tube 113. The second driving member 500 is configured to drive the third inner tube 113 to move axially relative to the second inner tube 112.

Herein, the first driving member 400 and the second driving member 500 are connected by a fluid pipeline 600. Both the first driving member 400 and the second driving member 500 are hydraulic cylinders.

In this embodiment, the hydraulic drive system is provided, achieving coordinated control over the multiple telescoping tube sections. This represents a significant technological advancement in the automation level and operational precision of the support assembly. Both the first driving member 400 and the second driving member 500 adopt a hydraulic cylinder design. They are respectively mounted at the distal ends of the outer tube 110 and the second inner tube 112, and are interconnected by the fluid pipeline 600 to form a closed-loop hydraulic system.

First, the hydraulic system can provide significant driving force, enabling easy unlocking control even when carrying heavy equipment. Compared to mechanical or electric drives, the hydraulic system offers greater output force and smoother response, making it suitable for professional-level photography or industrial measurement applications with extremely high stability requirements.

Second, the two hydraulic cylinders connected by the fluid pipeline 600 can operate in synchronous or differential working modes. In synchronous mode, the two cylinders can move in coordination, allowing the outer tube 110, the first inner tube 111, the second inner tube 112, and the third inner tube 113 to extend or retract simultaneously according to a preset ratio. This enables one-touch unlocking or one-touch locking functions. In differential mode, the position of a specific tube section can be independently controlled, achieving more flexible height and angle adjustments.

Furthermore, the fluid pipeline 600 can be made of high-pressure, wear-resistant material and can incorporate precise hydraulic control valve assemblies inside. This allows for accurate adjustment of oil fluid flow and pressure, thereby achieving precise control over the telescoping speed and locking force. In some embodiments, the system can also integrate pressure sensors and position feedback devices, to provide real-time operational status monitoring and data support for automatic control and safety protection.

The dual-hydraulic-cylinder drive design is suitable for professional scenarios requiring precise positioning and frequent adjustments, such as cinematography, large-scale event live broadcasts, and precision industrial measurement. Through simple control operations, complex position adjustments can be achieved, significantly improving work efficiency and operational convenience.

The present disclosure further proposes a photography support frame 700, which includes a mounting seat 710, an operation member 712, and a plurality of support assemblies with the adjustable locking degree as described in the foregoing embodiments. The specific structure of these support assemblies refers to the above embodiments. Since the photography support frame 700 incorporates all the technical solutions of the above-mentioned embodiments, it possesses at least all the technical effects brought by those solutions, which will not be reiterated here. The plurality of support assemblies are connected to the mounting seat 710, and the mounting seat 710 is configured to mount photographic equipment.

An operation member 712 is disposed on the mounting seat 710. It is connected to the first driving member 400 and the second driving member 500 of each support assembly and is configured to output driving force to the first driving member 400 and the second driving member 500 of each support assembly.

In this embodiment, the mounting seat 710 is located at the top of the entire support frame. It can be made of high-strength aluminum-magnesium alloy through precision casting, ensuring sufficient strength and rigidity while achieving a lightweight design. The mounting seat 710 can also feature a standard quick-release plate interface to be compatible with mainstream photographic equipment on the market. Additionally, it can be equipped with a level and angle scales to facilitate accurate equipment positioning by photographers. In this embodiment, the bottom of the mounting seat 710 is connected to the multiple support assemblies via precision spherical joints. This connection method ensures structural stability while providing a certain degree of angular adjustment freedom to meet the needs of different shooting scenarios.

The operation member 712 is positioned on the side of the mounting seat 710, forming a centralized control center that allows photographers to operate the entire support frame without bending over. The operation member 712 can be a control valve assembly, a hydraulic pressure gauge, and a multifunction control handle. It forms a complete hydraulic control network with the first driving member 400 and the second driving member 500 of each support assembly via fluid lines. The operation member 712 can house an efficient micro hydraulic pump, which generates driving force either manually or electrically. This force is then evenly distributed to each support assembly through a distribution system.

The design of the hydraulic control system allows photographers to control the telescopic state of each support assembly simultaneously or independently, enabling various complex support configurations. For example, when shooting on inclined ground, the length of each support foot can be adjusted differentially to ensure the mounting seat 710 remaining level. For shots requiring special angles, a particular support foot can be extended to form a tilted support configuration, providing possibilities for creative shots.

Further, the photography support frame 700 of the present disclosure can integrate multiple user-friendly designs. For instance, the operation handle employs an ergonomic design, ensuring ease operation even when wearing gloves. For another example, the control valve assembly utilizes color coding and tactile feedback design, allowing for accurate identification in low-light environments. Additionally, the fluid lines are made of low-temperature resistant materials and feature an explosion-proof design to ensure reliability in extreme environments. Moreover, the system can incorporate an emergency locking function that can quickly lock all support feet in unexpected situations, protecting expensive photographic equipment.

Benefiting from the adjustable locking degree technology described in all the foregoing embodiments, this photography support frame 700 overcomes the shortcomings of traditional products in term of locking adjustment.

Whether performing tracking shots from a slightly vibrating vehicle or conducting long exposures in strong wind environments, this support frame provides stable and reliable support. Its innovative hydraulic drive and centralized control design significantly enhance the efficiency and convenience of professional photography work, representing the direction of technological development for photographic auxiliary equipment.

In summary, the photography support frame 700 proposed by the present disclosure systematically integrates all the technical advantages of the aforementioned support assembly with an adjustable locking degree and adds centralized control functionality.

The above description is merely some embodiments. Neither the text nor the drawings shall be construed as limiting the scope of the present disclosure. Any equivalent structural modifications made based on the description and drawings of the present disclosure, or any direct or indirect application in other related technical fields, shall be included within the scope of the present disclosure.

What is claimed is:

1. A support assembly with an adjustable locking degree, configured to support an equipment, the support assembly comprising:
a telescopic tube assembly, comprising:
an outer tube;
a first inner tube, disposed within the outer tube and being capable of sliding relative to the outer tube in an axial direction; and
a second inner tube, disposed within the first inner tube and being capable of sliding relative to the first inner tube in the axial direction;
a first locking assembly, comprising:
a first bushing, connected to one end of the outer tube, a peripheral wall of the first bushing defining an avoiding space;
a second bushing, connected to one end of the first inner tube, the second bushing being provided with a first connecting portion which is capable of passing through the avoiding space; and
a locking sleeve, an inner wall of the locking sleeve being provided with a second connecting portion for cooperating with the first connecting portion, one end of the locking sleeve being arranged with a first abutting portion which is linked to the locking sleeve, an inner wall of the first abutting portion abutting against the second inner tube, an outer wall of the first abutting portion embedding into a gap formed between the first bushing and the second inner tube, and the outer wall of the first abutting portion being configured to be tapered.

2. The support assembly according to claim 1, wherein one end of the first bushing close to the first abutting portion is provided with a second propping ring, and an inner wall of the second propping ring abuts against the outer wall of the first abutting portion.

3. The support assembly according to claim 2, wherein the first connecting portion is an external thread, the second connecting portion is an internal thread, and the first bushing is connected to the second propping ring via a threaded connection of the external thread and the internal thread.

4. The support assembly according to claim 2, wherein an inner wall of the second propping ring contacts with the outer wall of the first abutting portion, and the inner wall of the second propping ring and the outer wall of the first abutting portion are both configured to be tapered.

5. The support assembly according to claim 3, wherein one end of the second propping ring close to the first abutting portion is arranged with a first protrusion.

6. The support assembly according to claim 2, wherein one end of the locking sleeve defines an annular groove extending along an inner wall of the locking sleeve, an end of the first abutting portion opposite to the second propping ring is arranged with a second protrusion, the second protrusion is clamped in the annular groove, and the locking sleeve is capable of rotating relative to the second propping ring when subjected to an external rotational force.

7. The support assembly according to claim 1,
wherein the telescopic tube assembly further comprises:
a third inner tube, disposed within the second inner tube; and
a fourth inner tube, disposed within the third inner tube;
the support assembly further comprises:
a second locking assembly, disposed at one end of both the second inner tube and the third inner tube, wherein a structure of the second locking assembly is identical to that of the first locking assembly.

8. The support assembly according to claim 7, further comprising:
a first driving member, disposed at another end of the outer tube, the first driving member comprising an executing end extended into the outer tube and connected to another end of the first inner tube, and the first driving member being configured to drive the first inner tube to move axially relative to the outer tube.

9. The support assembly according to claim 8, further comprising:
a second driving member, disposed at another end of the second inner tube, the second driving member comprising an execution end extended into the second inner tube and connected to the third inner tube;
the second driving member being configured to drive the third inner tube to move axially relative to the second inner tube;
wherein the first driving member and the second driving member are connected by a fluid pipeline, and both the first driving member and the second driving member are hydraulic cylinders.

10. A photography support frame, comprising:
an operation member;
a mounting seat configured to mount photographic equipment; and
a plurality of support assemblies of claim 8, the plurality of support assemblies being connected to the mounting seat;
wherein the operation member is connected to the first driving member of each support assembly and configured to output driving force to the first driving member of each support assembly.

11. The photography support frame according to claim 10, wherein the photography support assembly further comprises:
a second driving member, disposed at another end of the second inner tube, the second driving member having an execution end extended into the second inner tube and connected to the third inner tube, and the second driving member being configured to drive the third inner tube to move axially relative to the second inner tube;
wherein the first driving member and the second driving member are connected by a fluid pipeline, and both the first driving member and the second driving member are hydraulic cylinders.

12. The photography support frame according to claim 11, wherein the operation member is connected to the first driving member of each support assembly and configured to output driving force to the first driving member, and is also connected to the second driving member of each support assembly and configured to output driving force to the second driving member.

13. The photography support frame according to claim 12, wherein the end of the first bushing close to the first abutting portion is provided with a second propping ring, and an inner wall of the second propping ring abuts against the outer wall of the first abutting portion.

14. The photography support frame according to claim 13, wherein the first connecting portion is an external thread, the second connecting portion is an internal thread, and the first bushing is connected to the second propping ring via a threaded connection structure between the first connecting portion and the second connecting portion.

15. The photography support frame according to claim 14, wherein an inner wall of the second propping ring contacts with the outer wall of the first abutting portion, and the inner wall of the second propping ring and the outer wall of the first abutting portion are both configured to be tapered.

16. The photography support frame according to claim 15, wherein one end of the second propping ring close to the first abutting portion is arranged with a first protrusion.

17. The photography support frame according to claim 13, wherein one end of the locking sleeve defines an annular groove extending along an inner wall of the locking sleeve, and an end of the first abutting portion opposite to the second propping ring is arranged with a second protrusion, the second protrusion is clamped in the annular groove, and the locking sleeve is configured to rotate relative to the second propping ring via an external rotational force.

18. The photography support frame according to claim 10,
wherein the telescopic tube assembly further comprises:
a third inner tube, disposed within the second inner tube; and
a fourth inner tube, disposed within the third inner tube;
the support assembly further comprises:
a second locking assembly, disposed at one end of the second inner tube and one end of the third inner tube, wherein a structure of the second locking assembly is identical to that of the first locking assembly.
